(19) United States
(12) Patent Application Publication
(10) Pub. No.: US 2007/0262498 A1
(43) Pub. Date: Nov. 15, 2007

(54) Manufacturing method of honeycomb structured body

(76) Inventors: Takamitsu Saijo, Neumann Janos (HU); Kenichiro Kasai, Gifu (JP); Koji Higuchi, Gifu (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/704,189

(22) Filed: Feb. 9, 2007

(30) Foreign Application Priority Data
Feb. 28, 2006 (EP) 06110533.4

(51) Int. Cl. C04B 35/64

(52) U.S. Cl. 264/630

(57) ABSTRACT

A manufacturing method of a honeycomb structured body including a honeycomb fired body of the present invention comprises: fabricating a pillar-shaped honeycomb molded body having a large number of cells longitudinally placed in parallel with one another with a cell wall there between by molding a ceramic raw material, and firing of the honeycomb molded body, wherein the manufacturing method further includes removing of extraneous matters adhered to a surface of the honeycomb fired body after the honeycomb molded body has been fired.

### CROSS-REFERENCE TO RELATED APPLICATIONS

This application claims priority of EP 06110533.4 filed on Feb. 28, 2006. The contents of this application are incorporated herein by reference in their entirety.

### BACKGROUND OF THE INVENTION

1. Field of the Invention

The present invention relates to a manufacturing method of a honeycomb structured body.

2. Discussion of the Background

In recent years, particulates such as soot and the like contained in exhaust gases discharged from internal combustion engines of vehicles, such as buses and trucks, and construction machines, have raised serious problems as those particulates are harmful to the environment and the human body.

There have been proposed various honeycomb filters using honeycomb structured bodies made from porous ceramics, which serve as filters capable of collecting particulates in exhaust gases to purify the exhaust gases.

Conventionally, when a honeycomb structured body is manufactured, first, a ceramic powder as raw material powder and binder are mixed, and a dispersant solution and the like is added and mixed to prepare a moist mixture. Then, this moist mixture is successively extrusion molded with a dice, and the extruded molded body is cut to a predetermined length so that a rectangular pillar shaped honeycomb molded body is fabricated.

Next, the obtained honeycomb molded body is dried using a micro-wave dryer or a hot-air dryer; then, predetermined cells are sealed, to form a honeycomb molded body in which either end of each of the cells is sealed by a plug material layer, and this honeycomb molded body is subjected to degreasing treatment thereafter; subsequently, the degreased honeycomb molded body is placed in a firing jig to carry out firing treatment so that a honeycomb fired body is manufactured.

Then, after placing a cavity holding material on the side face of the honeycomb fired body, a sealing material paste is applied to bond the honeycomb fired bodies to one another with a space through the cavity holding material, to fabricate an aggregated body of a honeycomb fired body in which a number of honeycomb fired bodies are bonded to one another through a sealing material layer (adhesive layer). Next, a cutting machine and the like is used to cut the obtained aggregated body of a honeycomb fired body to a predetermined shape such as a cylindrical shape, a cylindroid shape and the like, so that a ceramic block is formed; finally, the sealing material paste is applied to the periphery of the ceramic block, to form a sealing material layer (coat layer); thus, the manufacturing of a honeycomb structured body is completed.

If a powder is adhered to the under surface of the honeycomb fired body after firing, in which the firing jig (or the spacing member provided in the firing jig) has been in contact with, voids may occur in the sealing material layer which bonds the honeycomb fired bodies to one another, when manufacturing the above-mentioned aggregated body of a honeycomb fired body. When such voids occur, the adhesive strength of the sealing material layer may become insufficient and the durability of the honeycomb structured body may be reduced.

In JP-A10-238954, as a method for removing powder adhered to the under surface of a honeycomb fired body, there is disclosed a pusher type continuous furnace which: carries out heat treatment by successively sending in with a pusher, from the entrance of a furnace that is set in a predetermined temperature, an object to be subjected to treatment placed on the ceramic base plate; and removes the abrasive powder adhered to the under surface of the above-mentioned base plate by placing an aramid fiber brush in the exit of the above-mentioned pusher type continuous furnace.

The contents of JP-A 10-238954 are incorporated herein by reference in their entirety.

### SUMMARY OF THE INVENTION

A manufacturing method of a honeycomb structured body including a honeycomb fired body according to the present invention comprises: fabricating a pillar-shaped honeycomb molded body having a large number of cells longitudinally placed in parallel with one another with a cell wall therebetween by molding a ceramic raw material, and firing of the honeycomb molded body, wherein the manufacturing method further includes removing of extraneous matters adhered to a surface of the honeycomb fired body after the honeycomb molded body has been fired.

In the above-mentioned manufacturing method of a honeycomb structured body, desirably, the firing of the honeycomb molded body is carried out in a state in which the honeycomb molded body is placed in a firing jig through a spacing member, and after the firing, the extraneous matters deriving from the spacing member and adhered to the surface of the honeycomb fired body are removed. Furthermore, the material of the spacing member is desirably the same as that of the honeycomb fired body.

In the above-mentioned manufacturing method of a honeycomb structured body, desirably, the spacing member comprises a carbon cloth, a graphite sheet, or a carbon sheet. In the above-mentioned manufacturing method of a honeycomb structured body, desirably, the spacing member is provided in at least two places for one honeycomb molded body, and the spacing member has a flat shape.

In the above-mentioned manufacturing method of a honeycomb structured body, desirably, when firing the honeycomb molded body, a plurality of the honeycomb molded bodies are successively fired, and the installation position of the spacing member is at almost the same position for each honeycomb molded body. Furthermore, desirably, the removing of the extraneous matters is carried out by using at least one kind selected from the group consisting of a brush, a buff, a sponge, a grinding stone, air spraying, and a brush provided roller.

In the above-mentioned manufacturing method of a honeycomb structured body, desirably, the firing of the honeycomb molded body is carried out with the honeycomb molded body placed on a firing jig on which powder is dispersed, and after the firing, the extraneous matters deriving from the powder adhered to the surface of the honeycomb fired body are removed.

In the above-mentioned manufacturing method of a honeycomb structured body, desirably, at least two honeycomb molded bodies are fired in a state in which a first honeycomb molded body is placed on a firing jig through a spacing member, and further a second honeycomb molded body is placed on the first honeycomb molded body through a spacing member, and after the firing, the extraneous matters adhered to the surface of the honeycomb fired bodies deriving from the spacing member are removed.

In the above-mentioned manufacturing method of a honeycomb structured body, the extraneous matters adhered to an upper surface of the honeycomb fired body and the extraneous matters adhered to an under surface of the honeycomb fired body may be removed simultaneously or separately.

In the above-mentioned manufacturing method of a honeycomb structured body, desirably, the removing of the extraneous matters adhered to the surface of the honeycomb fired body is carried out by moving the honeycomb fired body on a belt conveyor, and pressing the honeycomb fired body against the belt conveyor by a pressing member.

In the above-mentioned manufacturing method of a honeycomb structured body, desirably, the removing of the extraneous matters adhered to the surface of the honeycomb fired body is carried out by stopping the moving of the honeycomb fired body on the belt conveyor for a predetermined time, and removing the extraneous matter while the moving is stopped.

In the above-mentioned manufacturing method of a honeycomb structured body, the removing of the extraneous matters may be carried out in a fixed range of the under surface and/or the upper surface of the honeycomb fired body, or may be carried out on the whole region of the under surface and/or the upper surface of the honeycomb fired body.

In the above-mentioned manufacturing method of a honeycomb structured body, the brush is desirably a channel strip brush, a channel-type roll brush, a wheel brush, a cup brush, a coil brush, a twist brush, a bevel brush or a pen brush, and material of the brush is desirably nylon fiber, aramid fiber, acrylic fiber, stainless steel lines, brass lines or wrapping lines.

The rotational frequency of the brush provided roller is desirably at least about 50 min⁻¹ and at most about 200 min⁻¹.

In the above-mentioned manufacturing method of a honeycomb structured body, desirably, the velocity of the air sprayed to the honeycomb fired body upon removing of the extraneous matters by the air spraying is at least about 1 m/sec and at most about 10 m/sec.

In the above-mentioned manufacturing method of a honeycomb structured body, desirably, the buff includes an abrasive grain containing disk type buff, an abrasive grain containing flap type buff, an abrasive grain containing swirl type buff, or a non-abrasive grain-polypropylene nonwoven fabric.

In the above-mentioned manufacturing method of a honeycomb structured body, desirably, the sponge includes an urethane sponge with abrasive grains adhered thereto, a nylon nonwoven fabric with abrasive grains adhered thereto, or an acrylic with abrasive grains adhered thereto.

In the above-mentioned manufacturing method of a honeycomb structured body, desirably, the grinding stone includes a resinoid grinding wheel, a magnesia grinding stone, a diamond wheel, a rubber control grinding stone or an epoxy control grinding stone.

In the above-mentioned manufacturing method of a honeycomb structured body, desirably, the honeycomb structured body may have a configuration in which a plurality of the honeycomb fired bodies are bonded to one another through a sealing material layer (adhesive layer), or may be formed by a single piece of the honeycomb fired body.

The above-mentioned manufacturing method of a honeycomb structured body desirably further comprises sealing of either end of each of the cells with a plug paste.

### BRIEF DESCRIPTION OF THE DRAWINGS

FIG. 1 is a perspective view schematically showing a degreasing jig related to one embodiment of the present invention.

FIG. 2A is a perspective view schematically showing a firing jig according to one embodiment of the present invention, and FIG. 2B is a perspective view schematically showing another firing jig according to one embodiment of the present invention.

FIG. 3A is a perspective view schematically showing an extraneous matters removing apparatus according to one embodiment of the present invention, and FIG. 3B is a perspective view schematically showing another extraneous matters removing apparatus according to one embodiment of the present invention.

FIG. 4 is a perspective view schematically showing an example of a honeycomb structured body manufactured by the manufacturing method according to one embodiment of the present invention.

FIG. 5A is a perspective view schematically showing a honeycomb fired body forming the above-mentioned honeycomb structured body manufactured by the manufacturing method according to one embodiment of the present invention, and FIG. 5B is an A-A line cross-sectional view thereof.

FIG. 6 is a cross-sectional view of an aggregated body of a honeycomb fired body manufactured by the manufacturing method according to one embodiment of the present invention.

FIGS. 7A and 7B are cross-sectional views for describing a honeycomb structured body manufacturing device provided with a cylindrical (can-type) jig used at the time of filling a sealing material paste, which is used in the manufacturing method according to one embodiment of the present invention.

### DESCRIPTION OF THE EMBODIMENTS

The manufacturing method of a honeycomb structured body including a honeycomb fired body according to embodiments of the present invention comprises:

fabricating a pillar-shaped honeycomb molded body having a large number of cells longitudinally placed in parallel with one another with a cell wall therebetween by molding a ceramic raw material, and

firing of the honeycomb molded body,

wherein

the manufacturing method further includes removing of extraneous matters adhered to a surface of the honeycomb fired body after the honeycomb molded body has been fired.

In accordance with the conventional manufacturing method of a honeycomb structured body, if there are extraneous matters and the like, deriving from the spacing member provided in the firing jig, on an under surface of the honeycomb fired body after firing, they need to be removed since defects tend to occur in the subsequent bonding of the honeycomb fired bodies to one another, and of the like processes; however, according to the embodiments of the present invention, the extraneous matters have been removed, and thus, for example, when the sealing material layer which bonds the honeycomb fired bodies to one another is formed, voids hardly occur in this sealing material layer while adhesive strength thereof is superior; thus, the durability of the honeycomb structured body will also be excellent.

In the manufacturing method of a honeycomb structured body according to the embodiments of the present invention, a pillar-shaped honeycomb molded body having a large number of cells longitudinally placed in parallel with one another with a cell wall therebetween is fabricated by a continuous extrusion-molding method, and after degreasing of the fabricated honeycomb molded body, firing is carried out to manufacture a honeycomb fired body. After firing, removing of the extraneous matters adhered to the surface of the honeycomb fired body is carried out. Here, at first, degreasing and firing of the honeycomb molded body, and removing of the extraneous matters on the surface of the honeycomb fired body are explained in detail, followed by description of other processes.

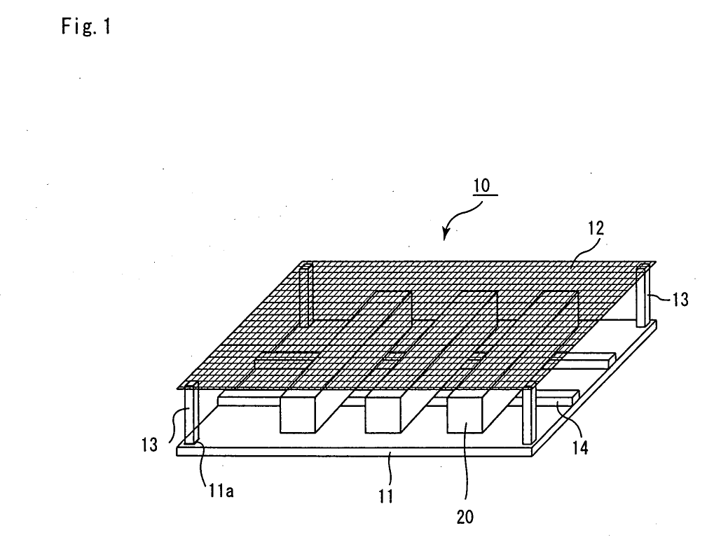

FIG. 1 is a perspective view schematically showing a degreasing jig related to one embodiment of the present invention.

This degreasing jig 10 is equipped with a flat shaped placing jig 11, a rectangular shaped grid-pattern body 12 provided so as to cover the placing jig 11 from a predetermined distance therefrom, and a pillar-shaped supporting material 13 fixed to the four corners of the grid-pattern body 12 to support the grid-pattern body 12. The supporting material 13 is configured so as to fit into a square pillar shaped through hole 11a formed in the four corners of the placing jig 11.

Narrow beltlike spacing members 14 are fixed in parallel on two or more positions of the placing jig 11, and a honeycomb molded body 20 is placed thereon through the spacing members 14. Then, the lower portion of the supporting materials 13 fixed to the grid-pattern body 12 are fitted into the through holes 11a of the placing jig 11 to install the grid-pattern body 12.

The degreasing treatment is carried out by sending in the degreasing jig 10 having such configuration to a degrease furnace through a belt conveyor. Since the grid-pattern body 12 is installed above the honeycomb molded body 20, even if fluid resulting from the decomposed organic substance drops down, it tends not to contact the honeycomb molded body 20, and since the circumference of the honeycomb molded body 20 is in an opened condition, degreasing treatment tends to progress favorably.

The degreasing treatment is normally carried out under oxidizing atmospheres such as air atmosphere, so that oxidative decomposition of the organic substance can be carried out. The type of the degrease furnace is not particularly limited, and may be a batch-type degrease furnace; however, it is desirable to be a continuous furnace provided with a belt conveyor so that the treatment can be carried out successively. Moreover, the degreasing temperature is desirably at least about 200° C. and at most about 600° C.

In the placing jig 11, the spacing members 14 are provided in order not to directly contact the honeycomb molded body 20 to the placing jig 11, and in FIG. 1, the spacing members 14 are placed in parallel with the long side of the placing jig 11, with the honeycomb molded body 20 being arranged so that the length direction thereof is perpendicular to the spacing members 14; however, the spacing members 14 may be placed perpendicular to the long side of the placing jig 11, with the honeycomb molded body 20 being arranged so that the length direction thereof is perpendicular to the spacing members 14.

After thus sending in the honeycomb molded body 20 to the degrease furnace and carrying out the degreasing treatment, the honeycomb molded body 20 subjected to the degreasing treatment is sent into a firing furnace to be fired (sintered). In the above-mentioned degreasing treatment, the degreasing jig 10 shown in FIG. 1 is not necessarily used as long as the jig may more easily prevent fluid resulting from decomposed organic substance to contact the honeycomb molded body 20 even when the organic substance drops down, while it is a jig in which the degreasing treatment may be more easily progressed sufficiently. However, in such a jig, it may be difficult to completely prevent extraneous matters deriving from the organic substance to adhere to the honeycomb fired body.

Firing is carried out after the degreasing. Here, the honeycomb molded body 20 subjected to the degreasing treatment may be transferred to a box shape firing jig with the lid part opened, to carry out a firing treatment; however, since the honeycomb molded body 20 subjected to the degreasing treatment is fragile and breakable, it is not preferable to move the honeycomb molded body 20 by holding it.

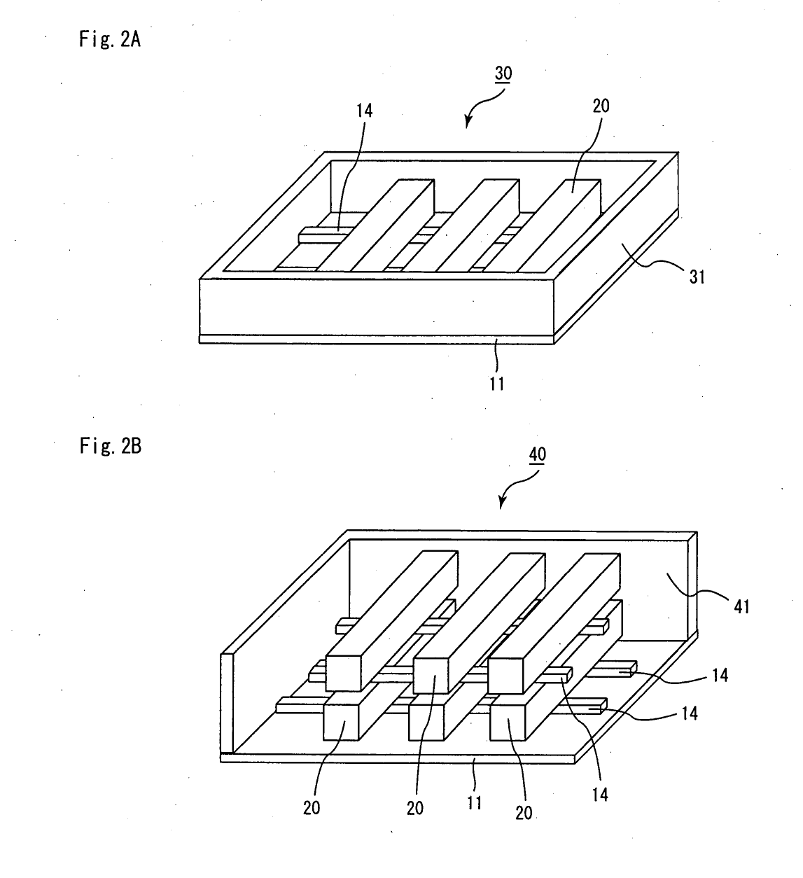

Therefore, as shown in FIG. 2A, the honeycomb molded body 20 is left to be placed on the placing jig 11 without being moved, and a frame shaped side wall member serving as a side wall 31 is provided on the placing jig 11, to form a firing jig 30; and it is desirable to pile up and send in the firing jig 30 having such configuration to a firing furnace.

Here, FIG. 2A is a perspective view schematically showing the firing jig 30 according to one embodiment of the present invention, and FIG. 2B is a perspective view schematically showing another firing jig 40 according to one embodiment of the present invention.

The type of the firing furnace is not particularly limited and a batch-type firing furnace may be used; however, a continuous furnace is preferable. The continuous furnace is desirably provided with: a deaerating chamber which at first takes in the honeycomb molded body 20 after degreasing, and changes atmosphere into anon-oxidizing atmosphere from air atmosphere; a preheating chamber which increases temperature gradually; a heat chamber which heats to nearly the firing temperature; a slow cooling chamber which lowers temperature gradually; a cooling room which further lowers the temperature; and a deaerating chamber which changes atmosphere from non-oxidizing atmosphere to air atmosphere.

It is preferable that the atmosphere of the firing furnace normally has inert gas atmosphere such as nitrogen, argon and the like.

The honeycomb fired body taken out from this firing furnace is cooled to form a honeycomb structured body which is a combination of a plurality of honeycomb fired bodies 25 bonded to one another; however, the portion formed at the bottom face of the degreasing jig (firing jig) which contacts the spacing member 14 and the like for placing the honeycomb molded body 20, becomes more likely to have powder and the like adhered thereto. Therefore, in the embodiments of the present invention, the extraneous matters deriving from the spacing member and adhered to the surface of the honeycomb fired body 25 after firing has been removed.

As mentioned above, the spacing member 14 may be provided on the placing jig 11 used in common with both the degreasing jig and the firing jig, or may be provided on a bottom plate of a firing jig other than the degreasing jig. Moreover, the firing jig is not limited to those shown in FIGS. 2A and 2B.

However, in the following description, the spacing member 14 is described as being provided on the placing jig 11 in common with both the degreasing jig and the firing jig.

Although material of the spacing member 14 provided on the placing jig 11 which constitutes the firing jig 30 is not particularly limited, it is desirable to be the same material as that of the honeycomb fired body, or to be a carbon cloth, a graphite sheet, or a carbon sheet in order not to affect degreasing and firing of the honeycomb molded body 20.

When the material is the same as that of the honeycomb fired body, the density of the spacing member 14 is preferably at least about 0.5 g/cm³ and at most about 3.5 g/cm³, the density of the carbon cloth is preferably at least about 0.05 g/cm³ and at most about 1.0 g/cm³, the density of the graphite sheet is preferably at least about 0.5 g/cm³ and at most about 1.5 g/cm³, and the density of the carbon sheet is preferably at least about 1.0 g/cm³ and at most about 3.0 g/cm³.

In order not to contact the placing jig 11 directly to the honeycomb molded body 20, and in order to make the adherence area as small as possible, the spacing member 14 is desirably provided so as to support the honeycomb molded body at two positions, and in order to be able to remove the extraneous matters more easily at the removal process mentioned later, desirably, the spacing member 14 is to be provided at almost the same position for every placing jig 11.

Moreover, it is desirable that the spacing member 14 has a flat shape; however, in order to make the contact area small, desirably, the shape thereof is to be a long and narrow flat shape.

The material of the honeycomb fired body is not particularly limited and examples thereof include: nitride ceramics such as aluminium nitride, silicon nitride, boron nitride, and titanium nitride; carbide ceramics such as silicon carbide, zirconium carbide, titanium carbide, tantalum carbide, and tungsten carbide; and oxide ceramics such as alumina, zirconia, cordierite, mullite, and aluminum titanate; and the like.

Among these, non-oxide ceramics are preferable, and silicon carbide is especially preferable. This is because thermal resistance, mechanical strength, thermal conductivity and the like become superior.

Examples of the above-mentioned ceramics include: silicon containing ceramics in which metallic silicon is mixed therewith, ceramics bonded by silicon or a silicate compound, and of the like ceramics, and for example, ceramics in which metallic silicon is mixed with silicon carbide is preferably used.

According to the above-mentioned explanation, the honeycomb molded body is placed on the spacing member 14 provided on the placing jig 11; however, in the embodiments of the present invention, the honeycomb molded body may be directly placed on a ceramic member as in the placing jig 11 in the degreasing and firing, or may be placed on the firing jig with powder and the like dispersed thereon.

This is because, the extraneous matters may be more easily removed by using the extraneous matters removing apparatus according to the embodiments of the present invention.

As shown in FIG. 2B, degreasing and firing treatment may be carried out as follows: when carrying out degreasing and firing, honeycomb molded bodies 20 of a predetermined number are placed on the spacing member 14; then, spacing members 14 are further arranged, for example, by two rows, on the placed honeycomb molded body 20; and on the honeycomb molded body 20 with the spacing member 14 placed thereon, another honeycomb molded body 20 is placed through the spacing member 14. In this case, it becomes easier to carry out the degreasing and firing of a large amount of honeycomb molded bodies 20. In FIG. 2B, the front side of the side wall 41 is not shown.

In this case, the powder resulting from the spacing member 14 adheres to the under surface and the upper surface of the obtained honeycomb fired body; therefore, it is necessary to remove the powder and the like adhered to both the under surface and the upper surface of the honeycomb fired body, however, by using the extraneous matters removing apparatus according to the embodiments of the present invention, the extraneous matters are more easily removed.

In the embodiments of the present invention, the method for removing the extraneous matters adhered to the surface of the honeycomb fired body is not particularly limited, and examples thereof include: a method for removing extraneous matters using a brush; a method for removing extraneous matters by spraying air; a method for removing extraneous matters by carrying out buffing and the like; a method for removing extraneous matters using sponge; a method for removing extraneous matters using a grinding stone; a method for removing extraneous matters using a polishing sheet; and the like.

First, description will be given of the method for removing extraneous matters using a brush provided roller.

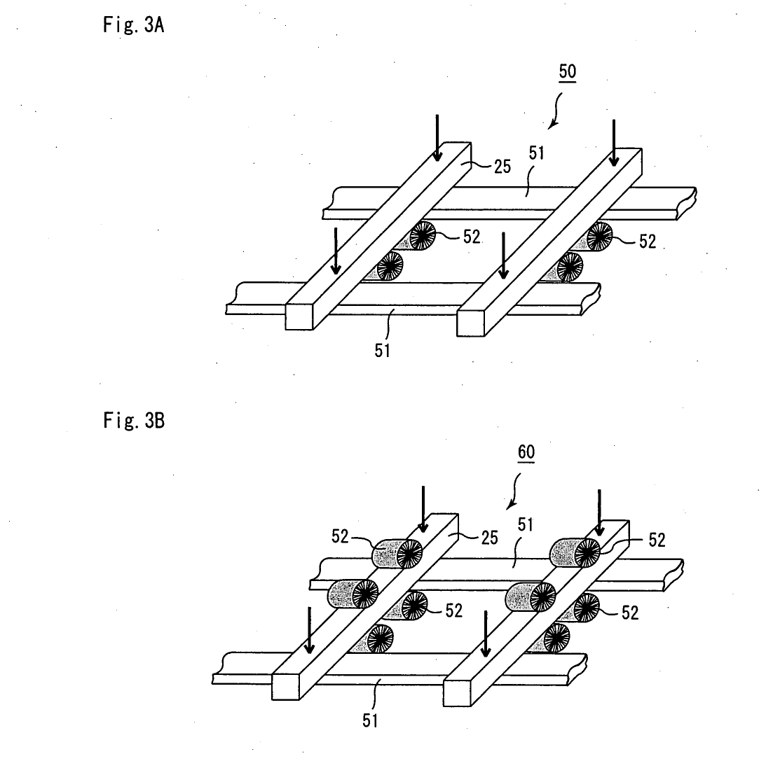

FIG. 3A is a perspective view schematically showing an extraneous matters removing apparatus according to one embodiment of the present invention, and FIG. 3B is a perspective view schematically showing another extraneous matters removing apparatus according to one embodiment of the present invention.

As shown in FIGS. 3A and 3B, in this extraneous matters removing apparatus 50, the honeycomb fired body 25 is moved by being placed on a belt conveyor 51 comprised of two belts, and so as to prevent the honeycomb fired body 25 to change its position, pressure is applied to the honeycomb fired body 25 from above, through a pressing member having a rod shape, a flat shape and the like, to press the honeycomb fired body 25 against the belt conveyor 51.

When applying pressure to the honeycomb fired body using the above-mentioned pressing member, pressure may be applied to a plurality of honeycomb fired bodies by one pressing member, or pressure may be applied to each honeycomb fired body by individual pressing members.

Here, it is preferable that the belt conveyor 51 is a belt conveyor comprised of two belts, because manufacturing of the extraneous matters removing apparatus becomes easier.

In the region through which the honeycomb fired body 25 passes, a brush provided roller 52 is arranged so that it contacts the under surface of the honeycomb fired body 25, and as the honeycomb fired body 25 moves, the rotating brush provided roller 52 contacts the under surface of the honeycomb fired body 25, and thus the extraneous matters are removed. The belt conveyor 51 may be configured so as to stop once when the under surface of the honeycomb fired body 25 comes to the region that contacts the brush provided roller 52.

By stopping the belt conveyor 51 for a certain period of time, the brush provided roller may be more easily contact the honeycomb fired body evenly, and therefore, the extraneous matters may be more easily removed without fail.

In the manufacturing method of a honeycomb structured body according to the embodiments of the present invention, together with removing the extraneous matters, the removed extraneous matters may be absorbed. Thus, the removed extraneous matters are more easily prevented from being adhered once again to the honeycomb fired body.

According to the above-mentioned configuration, the extraneous matters will not be removed from the portion that contacts the two belt conveyors 51 of the honeycomb fired body 25, nor the portion that does not contact the brush provided roller 52; however, as mentioned above, in the degreasing and firing, since the honeycomb molded body 20 is placed on the placing jig 11 through the narrow beltlike spacing member 14 provided thereon, powder or the like adheres only to this portion, and tends not to adhere to other portions. Since the portion that contacts the two belt conveyors 51 is not the same as the portion that contacts the spacing member 14, powder and the like is not adhered thereto; therefore, the extraneous matters may be more easily removed completely by the brush provided roller 52.

In the above-mentioned configuration, the brush provided roller 52 is configured only to contact a predetermined part of the honeycomb fired body; however, the brush provided roller 52 may also be configured to move in the length direction of the honeycomb fired body 25 within a fixed range, to remove the extraneous matters. In this case, even when the extraneous matters adhere to the honeycomb fired body 25 in a wide range, those extraneous matters may be more easily removed. The method for removing extraneous matters is not limited to such method, and a method in which the brush provided roller 52 is configured to contact the entire under and/or upper surface of the honeycomb fired body 25 may also be carried out to remove the extraneous matters.

Although the type of the brush is not limited and various types of brushes can be used, examples thereof include: a channel strip brush, a channel-type roll brush, a wheel brush, a cup brush, a coil brush, a twist brush, a bevel brush, a pen brush, and the like. These may be brushes of normal style or may be brushes with an axis. Moreover, the brush may be a so-called scourer.

These brushes may be, for example, bonded with a rotary motor and rotated, to carry out the method for removing the extraneous matters adhered to the honeycomb fired body 25; or, for example, the method for removing the extraneous matters can be carried out by a reciprocating motion of these brushes within a predetermined range.

Although the material of the brush is not particularly limited, examples thereof include: brushes using polymers such as nylon fiber, aramid fiber, acrylic fiber and the like; and metal wires such as stainless steel lines, brass lines, wrapping lines and the like.

When the firing treatment as shown in FIG. 2B is carried out and extraneous matters are adhered on both the upper surface and the under surface of the honeycomb fired body 25, extraneous matters adhered on the upper and under surface may be removed separately. In such a case, a mechanism in which the brush provided roller is provided on the upper surface and the pressing member on the under surface is placed in parallel with a mechanism in which the pressing member is provided on the upper surface and the brush provided roller on the under surface.

Moreover, extraneous matters adhered on the upper and under surface may be removed simultaneously, and in such a case, as shown in FIG. 3B, the brush provided roller 52 is provided at the same region for both the upper surface and under surface of the honeycomb fired body 25 so that the brush provided roller 52 contacts the upper and under surface to remove the extraneous matters. Here, the pressing member is not necessarily arranged.

As for the rotational frequency of the brush provided roller 52 shown in FIGS. 3A and 3B, at least about 50 min⁻¹ and at most about 200 min⁻¹ is preferable.

When the rotational frequency is within the above-mentioned range, then the extraneous matters may be more easily removed completely.

Next, description will be given of the method for removing extraneous matters by spraying air.

In this case, compressed air and the like is emitted from a nozzle and the like having a specific shape, to remove the extraneous matters adhered to the honeycomb fired body 25. Here, the extraneous matters within a predetermined range may be more easily removed by moving the nozzle. Also in this case, the honeycomb fired body 25 is desirably pressed down against the belt conveyor, to have its position fixed. When spraying the air, the velocity of the air sprayed to the honeycomb fired body 25 is desirably at least about 1 m/sec and at most about 10 m/sec.

This is because, when the velocity of the air is within the above-mentioned range, the extraneous matters may be reliably removed more easily.

Next, description will be given of the method for removing extraneous matters by carrying out buffing and the like.

In this method, the extraneous matters adhered to the honeycomb fired body 25 are removed by buffing or a method similar thereto.

Examples of a buff include: abrasive grain containing buffs such as a disk type buff, a flap type buff, a swirl type buff, and the like; and non-abrasive grain buffs such as polypropylene nonwoven fabric, and the like. As an abrasive grain used for an abrasive grain containing buff, examples thereof include, aluminium silicate, aluminum oxide, silicon carbide, and the like.

At the time of buffing, the following method is carried out: the honeycomb fired body 25 is placed on the belt conveyor 51 comprised of two belts, to be moved; and on the other hand, pressure is applied from above the honeycomb fired body 25 through a pressing member in order to prevent the honeycomb fired body 25 to change its position, and from the lower side thereof a buffing apparatus rises to carry out polishing. In this case, a method in which the honeycomb fired body 25 is moved again after the belt conveyor 51 stops, and buffing is carried out by rotation, reciprocating motion and the like, is desirably carried out.

The removing treatment by buffing is effective when the powder adhered to the honeycomb fired body 25 cannot be removed easily. In the above-mentioned method, buffing is carried out by placing the honeycomb fired body 25 on the belt conveyor; however, by using an apparatus which holds the honeycomb fired body 25, the honeycomb fired body 25 can be lifted up, to be subjected to buffing. In such a method, buffing may be more easily carried out on the entire under surface of the honeycomb fired body 25; thus, it may be more easily applied even to a case in which the extraneous matters are adhered to the entire under surface.

Next, description will be given of the method for removing extraneous matters by carrying out sponge polish treatment.

Sponge polish treatment refers to a method for removing extraneous matters by contacting sponge such as urethane sponge, nylon nonwoven fabric, acryl (sponge) and the like adhered with abrasive grains such as aluminium silicate, aluminum oxide, silicon carbide and the like to the honeycomb fired body 25.

Also in this case, as in the case of buffing, the following method is carried out: pressure is applied from above the honeycomb fired body 25 through a pressing member, to prevent the honeycomb fired body 25 to move, and on the other hand a sponge polish treatment apparatus rises from the lower side, to carry out polishing. Here, a method in which the honeycomb fired body 25 is moved again after the belt conveyor 51 stops, and sponge polish treatment is carried out by rotation, reciprocating motion and the like, is preferably carried out.

The removing treatment by sponge polish treatment is also an effective treatment when the powder adhered to the honeycomb fired body 25 cannot be removed easily. Moreover, an apparatus which holds the honeycomb fired body 25 may be used also in this method to lift up the honeycomb fired body 25, so that the sponge polish treatment can be carried out.

Next, description will be given of the method for removing extraneous matters using a grinding stone.

When removing extraneous matters using a grinding stone, the honeycomb fired body 25 is placed on the belt conveyor 51 comprised of two belts, to be moved; and on the other hand, pressure is applied from above the honeycomb fired body 25 through a pressing member in order to prevent the honeycomb fired body 25 to change its position, and from the lower side thereof a grinding stone polish apparatus rises to carry out polishing. In this case, a method in which the honeycomb fired body 25 is moved again after the belt conveyor 51 stops, and polishing is carried out by rotating the grinding stone or by reciprocating motion, is desirably carried out.

Examples of the kind of grinding stone used include: a resinoid grinding wheel (resin), a magnesia grinding stone (cement), a diamond wheel, a rubber control grinding stone, an epoxy control grinding stone and the like.

The removing treatment by polishing using a grinding stone is effective when the powder adhered to the honeycomb fired body 25 is firmly adhered thereto. In the above-mentioned method, polishing is carried out by placing the honeycomb fired body 25 on the belt conveyor; however, an apparatus which holds the honeycomb fired body 25 may be used to lift up the honeycomb fired body 25, so that polishing by a grinding stone can be carried out. In this case, polishing by a grinding stone may be more easily carried out on the entire under surface of the honeycomb fired body 25; thus, it may be more easily applied even to a case in which, extraneous matters are adhered to the entire under surface.

Next, description will be given of the method for removing extraneous matters using a polishing sheet.

In this method, the polishing sheet contains a sheet abrasive having a grain size of #A60 to #A240, and this sheet contacts the honeycomb fired body 25, so that the extraneous matters are removed.

Moreover, the polishing sheet refers to a object in which abrasive grains such as aluminium silicate, aluminum oxide, silicon carbide and the like are adhered to urethane sponge, nylon nonwoven fabric, acryl (sponge) and the like, and the sheet to which these abrasive grains are adhered is contacted to the honeycomb fired body 25.

Here, as in the case of buffing, the following method is carried out: pressure is applied from above the honeycomb fired body 25 through a pressing member to prevent the honeycomb fired body 25 to move; and on the other hand, an apparatus of sheet polish treatment rises from the bottom, to carry out polishing by rotation, reciprocating motion and the like. In this case, the method in which the honeycomb fired body is moved again after the belt conveyor 51 stops, and the sponge polish treatment is carried out, is preferably carried out.

The removing treatment by sheet polish treatment is also effective when the powder adhered to the honeycomb fired body 25 cannot be removed easily.

In the above-mentioned methods, that is, the method for removing extraneous matters using a brush provided roller, the method for removing extraneous matters by spraying air, the method for removing extraneous matters by carrying out buffing and the like, the method for removing extraneous matters by carrying out sponge polish treatment, the method for removing extraneous matters using a grinding stone, and the method for removing extraneous matters using a polishing sheet, when extraneous matters are adhered both on the upper and under surface, the extraneous matters on the upper and under surface may be removed simultaneously, or may be removed separately. Moreover, when the extraneous matters are to be removed, the removing may be carried out on the entire surface of the honeycomb fired body 25, or may be carried out locally on only one part.

The honeycomb fired body 25 from which the extraneous matters have been removed by carrying out treatment using the above-mentioned methods, is subjected to the following process, and as is mentioned later, when bonding the honeycomb fired bodies to one another on the side face of a plurality of honeycomb fired bodies, the cavity holding material for making space between the honeycomb fired bodies to a predetermined space is adhered therebetween, and then, the honeycomb fired bodies are bonded to one another through a sealing material layer (adhesive layer) to fabricate an aggregated body of a honeycomb fired body.

Here, since the extraneous matters of the honeycomb fired body have been removed, the cavity holding material may be more easily adhered favorably and the aggregated body of a honeycomb fired body may be fabricated more easily. Moreover, since the extraneous matters of the honeycomb fired body have been removed, the honeycomb fired bodies 25 may be more easily bonded to one another favorably so that a honeycomb structured body in which the honeycomb fired bodies are favorably adhered to one another may be more easily manufactured.

On the other hand, an aggregate body of honeycomb fired bodies may be manufactured by repeating a process of applying a sealing material layer (adhesive layer) on a honeycomb fired body and then laterally disposing or piling up another honeycomb fired body thereon. In this case also, since the extraneous matters of the honeycomb fired body have been removed, the honeycomb fired bodies may be more easily bonded to one another favorably so that it may become easier to manufacture a honeycomb structured body in which the honeycomb fired bodies are favorably adhered to one another.

As mentioned above, description has been given of the part which is directly relevant to the embodiments of the present invention, that is, description about degreasing and firing of the honeycomb molded body, and removing of the extraneous matters on the surface of the honeycomb fired body; therefore, description of the manufacturing method of a honeycomb structured body including other processes will be given hereinafter in the order of process. Only a brief description will be given of degreasing and firing of the honeycomb molded body, and removing of the extraneous matters.

Moreover, here, description will be given of the manufacturing method of a honeycomb structured body, by taking as an example a case in which a honeycomb structured body comprised of silicon carbide is manufactured by using silicon carbide powder as inorganic powder.

Of course, the material of the honeycomb structured body manufactured with the manufacturing method according to the embodiments of the present invention is not necessarily limited to silicon carbide, and examples thereof include the same material and the like as that of the above-mentioned honeycomb fired body.

(1) First, silicon carbide powder and organic binder (organic powder) which differ in average particle diameter are dry blended, to prepare mixed powder.

Although the particle size of the silicon carbide powder is not particularly limited, silicon carbide powder less likely to shrink in the succeeding firing is preferably used, and for example, powder with a combination of 100 parts by weight of powder having an average particle diameter of at least about 0.3 μm and at most about 50 μm, and at least about 5 parts by weight and at most about 65 parts by weight of powder having an average particle diameter of at least about 0.1 μm and at most about 1.0 μm is preferable.

In order to adjust the pore diameter and the like of the honeycomb fired body, it is necessary to adjust the firing temperature. The pore diameter can also be adjusted by adjusting the particle size of the inorganic powder.

The organic binder is not particularly limited, and examples thereof may include: methyl cellulose, carboxymethyl cellulose, hydroxyethyl cellulose, polyethylene glycol and the like. Among these, methyl cellulose is desirably used.

Normally, the blending quantity of the above-mentioned organic binder is desirably at least about 1 parts by weight and at most about 10 parts by weight for 100 parts by weight of the inorganic powder.

(2) Next, a liquefied plasticizer, a liquid lubricant, and water are mixed to prepare a liquid mixture, and then the mixed powder prepared in the above-mentioned process (1), and the above-mentioned liquid mixture are mixed by using a wet-mix operator, to prepare a moist mixture for manufacturing a molded body.

The plasticizer is not particularly limited, and examples thereof may include glycerol and the like.

The lubricant is also not particularly limited, and examples thereof may include: a polyoxyalkylene compound such as polyoxyethylene alkyl ether, polyoxypropylene alkyl ether, and the like.

Specific examples of the lubricant include, for example, polyoxyethylene mono-butyl ether, polyoxypropylene mono-butyl ether, and the like.

Moreover, there may be cases in which the moist mixture does not contain the plasticizer and the lubricant.

When preparing the moist mixture, a dispersant solution may be used, and examples thereof include: water, an organic solvent such as benzene, alcohol such as methanol, and the like.

Furthermore, a molding assistant may be added in the moist mixture.

Moreover, a pore-forming agent, such as balloons that are fine hollow spheres composed of oxide-based ceramics, spherical acrylic particles or graphite, and the like may be added to the moist mixture, if necessary.

(3) After the moist mixture has been prepared, it is carried to an extrusion-molding machine by a carrier machine, and a pillar-shaped honeycomb molded body having a large number of cells longitudinally placed in parallel with one another with a cell wall therebetween is fabricated by extrusion molding.

Next, the above-mentioned honeycomb molded body is dried by using a micro-wave dryer, a hot-air dryer, a dielectric dryer, a decompression dryer, a vacuum dryer, a freeze dryer or the like.

Next, according to need, a predetermined amount of plug paste which forms plugs, is injected into ends of the outlet side of a cell group at the flow-in side and ends of the inlet side of a cell group at the flow-out side, to seal the cells.

Although the above-mentioned plug paste is not particularly limited, the plug paste which sets the porosity of a plug manufactured through the succeeding processes to at least about 30% and at most about 75% is desirably used, and for example, the same material paste as the above-mentioned moist mixture may be used.

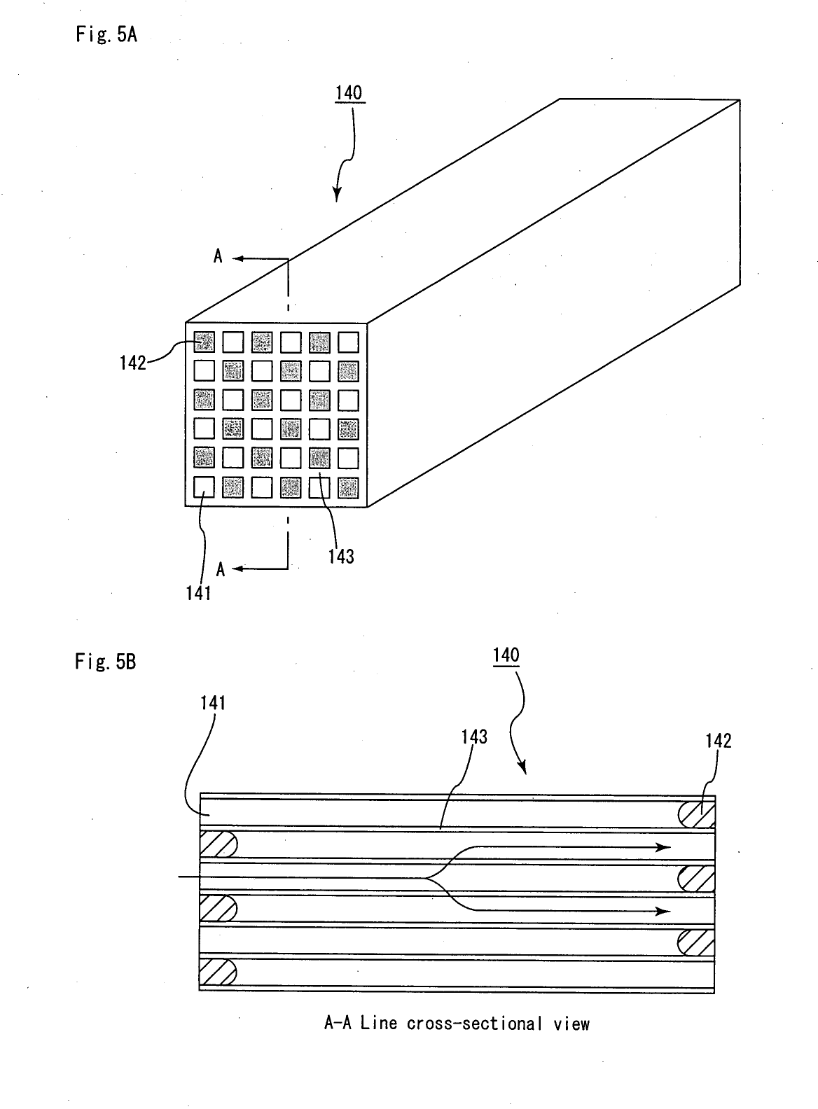

(4) Next, the honeycomb molded body filled with the above-mentioned plug paste is degreased (for example, at a temperature of at least about 200° C. and at most about 600° C.) and fired (for example, at a temperature of at least about 1400° C. and at most about 2300° C.) under a predetermined condition, to manufacture a honeycomb fired body consisting of one fired body in whole, and in which a plurality of cells are longitudinally placed in parallel with one another with a cell wall therebetween, with either end of the above-mentioned cells being plugged (see FIGS. 5A and 5B).

As for the degreasing and firing conditions of the honeycomb molded body, a conventional condition to manufacture a filter comprised of porous ceramics is applicable. When carrying out the degreasing treatment, the degreasing jig 10 shown in FIG. 1 can be used, and when carrying out the firing treatment, the firing jigs 30 and 40 shown in FIGS. 2A and 2B can be used. Then, the extraneous matters adhering to the honeycomb fired body 25 is removed by the above-mentioned method.

(5) Next, if necessary, a cavity holding material which serves as a spacer is adhered to the side face of the honeycomb fired body, while a sealing material paste serving as a sealing material layer (adhesive layer) is applied in uniform thickness, to form a sealing material paste layer, and on this sealing material paste layer, successive piling-up of other honeycomb fired bodies is repeated, to fabricate an aggregated body of a honeycomb fired body of a predetermined size.

In the manufacturing method of a honeycomb structured body according to the embodiments of the present invention, after piling up the required number of honeycomb fired bodies through the cavity holding material, the sealing material paste may be filled into the cavity between the honeycomb fired bodies in one lot.

Examples of the sealing material paste include a material comprising inorganic fibers and/or inorganic particles in addition to an inorganic binder and an organic binder.

With respect to the inorganic binder, for example, silica sol, alumina sol and the like may be used. Each of these may be used alone or two or more kinds of these may be used in combination. Among the inorganic binders, silica sol is more desirably used.

With respect to the organic binder, examples thereof may include polyvinyl alcohol, methyl cellulose, ethyl cellulose, carboxymethyl cellulose and the like. Each of these may be used alone or two or more kinds of these may be used in combination. Among the organic binders, carboxymethyl cellulose is more desirably used.

With respect to the inorganic fibers, examples thereof may include ceramic fibers such as silica-alumina, mullite, alumina, silica and the like. Each of these may be used alone or two or more kinds of these may be used in combination. Among the inorganic fibers, alumina fibers are more desirably used.

With respect to the inorganic particles, examples thereof may include carbides, nitrides and the like, and specific examples may include inorganic powder and the like made from silicon carbide, silicon nitride, boron nitride and the like. Each of these may be used alone, or two or more kinds of these may be used in combination. Among the inorganic particles, silicon carbide having an excellent thermal conductivity is desirably used.

Furthermore, a pore-forming agent, such as balloons that are fine hollow spheres composed of oxide-based ceramics, spherical acrylic particles or graphite, may be added to the above-mentioned sealing material paste, if necessary.

The above-mentioned balloons are not particularly limited and, for example, alumina balloons, glass micro-balloons, shirasu balloons, fly ash balloons (FA balloons), mullite balloons and the like may be used. Among these, alumina balloons are more desirably used.

(6) Next, this aggregated body of a honeycomb fired body is heated to dry and solidify the sealing material paste layer, so that a sealing material layer (adhesive layer) is formed.

Next, a diamond cutter and the like is used, to cut the aggregated body of a honeycomb fired body in which a plurality of honeycomb fired bodies are adhered to one another through sealing material layers, so that a cylindrical ceramic block is fabricated.

The shape of the above-mentioned ceramic block manufactured with this manufacturing method is not limited to a cylindrical shape, and may be a cylindroid shape or other pillar shapes.

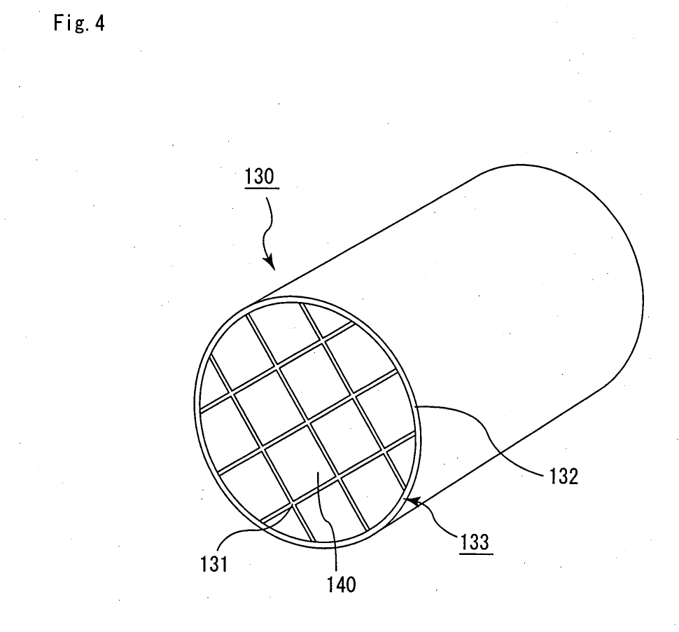

Furthermore, the above-mentioned sealing material paste is applied to the periphery of the ceramic block, to form a sealing material layer (coat layer). By carrying out such process, a honeycomb structured body with a sealing material layer (coat layer) provided on the peripheral portion of a cylindrical ceramic block in which a plurality of honeycomb fired bodies are bonded to one another through sealing material layers (adhesive layers) can be manufactured (see FIG. 4).

FIG. 4 is a perspective view schematically showing an example of a honeycomb structured body manufactured by the manufacturing method according to one embodiment of the present invention. FIG. 5A is a perspective view schematically showing a honeycomb fired body which constitutes a honeycomb structured body manufactured by the manufacturing method according to one embodiment of the present invention, and FIG. 5B is an A-A line cross-sectional view thereof.

In the honeycomb structured body 130, plural honeycomb fired bodies 140 as shown in FIGS. 5A and 5B are bonded to one another through a sealing material layer (adhesive layer) 131 to form a ceramic block 133, and a sealing material layer (coat layer) 132 is formed on the periphery of this ceramic block 133.

Moreover, as shown in FIGS. 5A and 5B, in the honeycomb fired body 140, a large number of cells 141 are placed in parallel with one another in the longitudinal direction, and the cell wall 143 which separates the cells 141 from each other functions as a filter.

That is, as shown in FIG. 5B, the cells 141 formed in the honeycomb fired body 140 are formed so that either of the ends of the flow-in side or the flow-out side of exhaust gas is sealed by a plug paste 142, while the exhaust gas which flows into one cell 141 definitely flows out of another cell 141, after passing the cell wall 143 which separates the cells 141 from each other; and at the time when exhaust gas passes this cell wall 143, particulates are captured in the cell wall 143 portion, to purify the exhaust gas.

In the manufacturing method of a honeycomb structured body according to the present invention, if necessary, the honeycomb structured body may support a catalyst thereafter.

The catalyst may also be supported on the honeycomb fired body prior to the manufacturing of the aggregated body.

If the catalyst is to be supported, desirably, an alumina film having a high specific surface area is formed on the surface of the honeycomb structured body, and catalyst such as a co-catalyst, platinum and the like is applied to the surface of this alumina film.

With respect to the method for forming the alumina film on the surface of the honeycomb structured body, examples thereof may include: a method in which the honeycomb structured body is impregnated with a solution of a metal compound containing aluminum such as Al(NO₃)₃ and the like and then heated; a method in which the honeycomb structured body is impregnated with a solution containing alumina powder, and then heated; and the like.

With respect to the method for applying the co-catalyst to the alumina film, examples thereof may include a method in which the honeycomb structured body is impregnated with a solution of a metal compound containing a rare-earth element, such as Ce(NO₃)₃, and then heated, and the like.

With respect to the method for applying a catalyst to the alumina film, examples thereof may include a method in which the honeycomb structured body is impregnated with a solution of diamine dinitro platinum nitric acid ([Pt(NH₃)₂(NO₂)₂]HNO₃, platinum concentration: about 4.53% by weight) and the like and then heated, and the like.

Furthermore, the catalyst may be applied through a method in which a catalyst is applied to an alumina particle in advance, to impregnate the honeycomb structured body with a solution containing alumina powder applied with the catalyst, and heat it thereafter.

The honeycomb structured body manufactured by the manufacturing method according to the embodiments of the present invention described above is a honeycomb structured body (hereinafter, also referred to as an aggregated honeycomb structured body) in which a plurality of honeycomb fired bodies are bonded to one another through sealing material layers (adhesive layers); however, the honeycomb structured body manufactured by the manufacturing method according to one embodiment of the present invention may be a honeycomb structured body (hereinafter, also referred to as an integral honeycomb structured body) in which the cylindrical ceramic block is constituted from a single honeycomb fired body.

When manufacturing such an integral honeycomb structured body, first, a honeycomb molded body is fabricated by using the same method as in the case in which the aggregated honeycomb structured body is manufactured, except that the size of the honeycomb molded body formed by extrusion molding is larger than that of the aggregated honeycomb structured body. Here, since the method and the like for mixing a raw material powder is the same as that of the method of manufacturing the aggregated honeycomb structured body, description thereof is omitted.

Next, as in the manufacturing method of the aggregated honeycomb structured body, the above-mentioned honeycomb molded body is dried by using a micro-wave dryer, a hot-air dryer, a dielectric dryer, a decompression dryer, a vacuum dryer, a freeze dryer or the like. Next, a predetermined amount of plug paste which forms plugs, is injected into ends of the outlet side of a cell group at the flow-in side and ends of the inlet side of a cell group at the flow-out side, to seal the cells.

Then, as in the manufacturing method of the aggregated honeycomb structured body, a ceramic block is manufactured by carrying out degreasing, firing, and extraneous matters removing treatment, and if necessary, forming of a sealing material layer (coat layer), to manufacture an integral honeycomb structured body. By carrying out the extraneous matters removing treatment, the sealing material layer can be favorably formed.

Moreover, a catalyst may also be supported on the above-mentioned integral honeycomb structured body with the above-mentioned method.

When an aggregated honeycomb structured body is manufactured at the time when a honeycomb structured body is to be manufactured with the above-mentioned manufacturing method, the main components of its material desirably comprises silicon carbide, or metallic silicon in addition to silicon carbide, and when an integral honeycomb structured body is manufactured, the material thereof desirably comprises cordierite or aluminum titanate.

The honeycomb structured body described in the present description is a honeycomb filter which captures particulates contained in exhaust gas. However, it is also possible to use the honeycomb structured body as a catalyst supporting member (honeycomb catalyst) which is able to convert exhaust gas.

The removal apparatus disclosed in JP-A 10-238954 is not configured for removing powder adhered to a product, but for preventing accidents caused by adhesion of a large amount of powder generated by reduction of the under surface of the tabular body serving as the base plate of the product; therefore, the object from which the powder is to be removed is completely different, and there was a problem that it is difficult to completely remove the large amount of powder adhered to the entire under surface.

In the manufacturing method of a honeycomb structured body according to the embodiments of the present invention, since extraneous matters adhered to the material serving as a product are removed, upon manufacturing a honeycomb molded body fired product, it may become easier to prevent defects that occur in the subsequent product manufacturing due to the extraneous matters adhered to the material serving as a product.

### EXAMPLES

Hereinafter, description for the present invention will be given in detail by means of examples; however, the present invention is not intended to be limited by these examples.

### Example 1

(1) 250 kg of α type silicon carbide powder having an average particle diameter of 10 μm, 100 kg of α type silicon carbide powder having an average particle diameter of 0.5 μm, and 20 kg of organic binder (methyl cellulose) were mixed, to prepare a mixed powder.

Next, 12 kg of lubricant (UNILUB made by NOF Corp.), 5.6 kg of plasticizer (glycerol), and 64 kg of water was mixed to prepare a fluid mixture separately, and this fluid mixture and the mixed powder were mixed using a wet-mix machine, so that a moist mixture was prepared.

Next, extrusion molding using this moist mixture was carried out, followed by cutting, to fabricate a honeycomb molded body.

(2) Next, the above-mentioned honeycomb molded body was dried by using a micro-wave dryer, and after having filled predetermined cells with a paste having a similar composition as the above-mentioned honeycomb molded body, the resulting honeycomb molded body was dried again using a dryer.

(3) Next, five honeycomb molded bodies, fabricated through the above-mentioned processes (1) and (2), were placed on the degreasing jig 10 shown in FIG. 1; then, the degreasing jig was sent into a degreasing furnace with a continuous system through a belt conveyor, to be heated at 300° C. under N₂ atmosphere.

The degreasing jig 10 used here was provided with the grid-pattern body 12 woven to have an open space (opening diameter) of 280 μm, with a linear wire made of stainless steel having 140 μm in diameter.

Moreover, at the time of placing the honeycomb molded bodies on the degreasing jig 10, the honeycomb molded bodies were placed through spacing members consisting of a carbon cloth having a density of 0.1 g/cm³.

(4) Next, the grid-pattern body 12 of the degreasing jig 10 was removed together with the supporting member 13, and a frame shaped side wall member serving as a side wall was placed on the placing jig 11, with the honeycomb molded bodies subjected to the degreasing treatment placed thereon, to provide a firing jig with degreased honeycomb molded bodies placed thereon.

Then, this firing jig was sent into a firing furnace to be fired at 2200° C. in a normal-pressure argon atmosphere for 3 hours, so that a honeycomb fired body having a shape as shown in FIGS. 5A and 5B, the size of 34 mm×34 mm×300 mm, the number of cells 45 pcs/cm², the thickness of a cell wall 0.25 mm, and made of a silicon carbide fired body, was fabricated.

(5) Next, the extraneous matters removing apparatus provided with the brush provided roller shown in FIG. 3A, was used to remove the extraneous matters adhered to the side face of the honeycomb fired body, deriving from carbon cloth.

(6) Next, a heat-resistant sealing material paste containing: 30% by weight of alumina fibers having an average fiber diameter of 20 μm; 21% by weight of silicon carbide grain having an average particle diameter of 0.6 μm; 15% by weight of silica sols; 5.6% by weight of carboxymethyl cellulose; and 28.4% by weight of water, was prepared.

The viscosity of this sealing material paste was 30 Pa·s at room temperature.

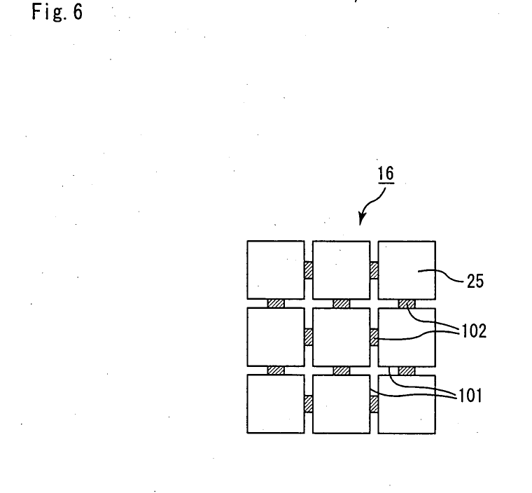

(7) Next, near the four corners of the side face of the honeycomb fired body 25, one each, four in total of a cavity holding material 102 comprised of a cardboard having 5 mm in diameter×1 mm in thickness with adhesive applied to both sides, was placed to be fixed. More specifically, the cavity holding material 102 was placed and fixed in the position where the shortest distance between the peripheral portion of the cavity holding material 102 and the two sides that share one corner of the side face were respectively set to 6.5 mm. Then, the honeycomb fired bodies 25 were bonded to one another through the cavity holding materials 102, by 4×4 pcs in lengthwise and breadthwise, to assemble an aggregated body 16 of a honeycomb fired body (see FIG. 6). In FIG. 6, the honeycomb fired bodies 25 are assembled by 3×3 pcs in lengthwise and breadthwise; however, as mentioned above, in the present Example, the honeycomb fired bodies 25 were actually assembled by 4×4 pcs in lengthwise and breadthwise.

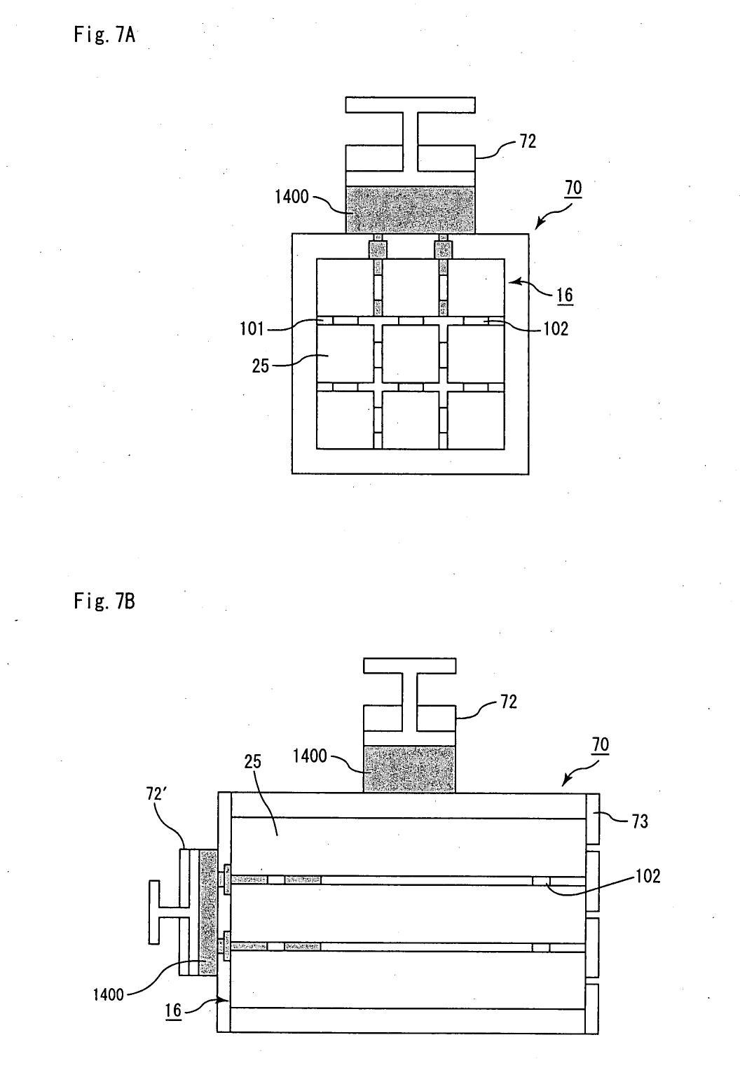

(8) Next, in a honeycomb structured body manufacturing device 70 as shown in FIGS. 7A and 7B, provided with paste supplying chambers 72 and 72′, and in which the inner peripheral size was 145 mm in height×145 mm in width×150 mm in length, the aggregated body 16 of a honeycomb fired body was installed. At a position corresponding to cavities 101 between the honeycomb fired bodies 25 constituting the aggregated body 16 of a honeycomb fired body, the honeycomb structured body manufacturing device 70 with three each of a supply groove having a width of 5 mm was provided, and which communicates through the paste supplying chambers 72 and 72′, together with the inside of the manufacturing device 70.

Furthermore, on the end portion of the opposite side from the side on which the paste supplying chamber 72′ of the honeycomb structured body manufacturing device 70 was attached, an opening-and-closing type bottom plate 73 which can be made to contact the end face was attached, and by closing this bottom plate 73 so that it could contact the end face of the aggregated body 16 of a honeycomb fired body, the cavities 101 between the honeycomb fired bodies 25 were sealed.

(8) Next, a sealing material paste 1400 was inserted into the paste supplying chambers 72 and 72′ of the honeycomb structured body manufacturing device 70, and 0.2 MPa pressure was applied from the supplying chamber 72 side (side face side of the aggregated body of a honeycomb fired body), while 0.05 MPa pressure was applied from the supplying chamber 72′ side (end face side of the aggregated body of a honeycomb fired body), to be pressed into the inner periphery of the honeycomb structured body manufacturing device 70, so that the sealing material paste 1400 was filled into the cavities between the honeycomb fired bodies.

Next, the aggregated body 16 of a honeycomb fired body in which the sealing material paste 1400 is filled between the honeycomb fired bodies 25, is dried at 100° C. for one hour, to cure the sealing material paste 1400; thus an aggregated body of a honeycomb fired body having a sealing material layer (adhesive layer) which is 1 mm in thickness, was formed.

(9) Next, using the diamond cutter, the above-mentioned aggregated body of a honeycomb fired body was cut to a cylindrical shape having 142 mm in diameter, and thus the cylindrical ceramic block 133 was fabricated.

(10) Next, a sealing material paste was prepared by mixing and kneading the following materials: as an inorganic fiber, 23.3% by weight of ceramic fiber (shot content: 3%, fiber length: 5 to 100 μm) which consists of alumina silicate; as an inorganic particle, 30.2% by weight of silicon carbide powder having an average particle diameter of 0.3 μm; as an inorganic binder, 7% by weight of silica sols (content of SiO₂ in sol: 30% by weight); as an organic binder, 0.5% by weight of carboxymethyl cellulose; and 39% by weight of water.

(11) Next, using the above-mentioned sealing material paste, a sealing material paste layer was formed on the peripheral portion of the ceramic block 133. Then, this sealing material paste layer was dried at 120° C., to manufacture a cylindrical honeycomb structured body which is 143.8 mm in diameter×150 mm in length, with a sealing material layer (coat layer) formed on the periphery thereof.

### Example 2

A honeycomb structured body was manufactured in a similar way as in Example 1, except that, in the process (5) of Example 1, a method for removing the extraneous matters by spraying compressed air from a nozzle was carried out as an alternative to removing the extraneous matters with the brush provided roller.

### Example 3

A honeycomb structured body was manufactured in a similar way as in Example 1, except that, in the process (5) of Example 1, a method for removing the extraneous matters by buffing was carried out as an alternative to removing the extraneous matters with the brush provided roller.

In the present Example, the disk type buff which contained aluminium silicate as an abrasive grain was used as the buff.

### Example 4

A honeycomb structured body was manufactured in a similar way as in Example 1, except that, in the process (5) of Example 1, a method for removing the extraneous matters by sponge polish was carried out as an alternative to removing the extraneous matters with the brush provided roller.

In the present Example, urethane sponge which contained aluminium silicate as an abrasive grain was used as the sponge.

### Example 5

A honeycomb structured body was manufactured in a similar way as in Example 1, except that, in the process (5) of Example 1, a method for removing the extraneous matters by grinding stone was carried out as an alternative to removing the extraneous matters with the brush provided roller.

In the present Example, the resinoid grinding wheel was used as the grinding stone.

### Example 6

A honeycomb structured body was manufactured in a similar way as in Example 1, except that, in the process (5) of Example 1, a method for removing the extraneous matters by polishing sheet was carried out as an alternative to removing the extraneous matters with the brush provided roller.

In the present Example, a polishing sheet containing a sheet abrasive having the grain size of #A60, while being made from aluminum oxide, in a sheet like object consisting of a nylon nonwoven fabric, was used as the polishing sheet.

### Example 7

(1) 80 kg of a type silicon carbide powder having an average particle diameter of 50 μm, 20 kg of silicon powder having an average particle diameter of 4.0 μm, and 11 kg of organic binder (methyl cellulose) were mixed to prepare mixed powder.

Next, 3.3 kg of lubricant (UNILUB made by NOF Corp.), 1.5 kg of plasticizer (glycerol), and an appropriate quantity of water was mixed to prepare a fluid mixture separately, and this fluid mixture and the mixed powder were mixed using a wet-mix machine, so that a moist mixture was prepared.

The α type silicon carbide powder used here was subjected to oxidation treatment at 800° C. for 3 hours. Next, extrusion molding using this moist mixture was carried out, followed by cutting, to fabricate a honeycomb molded body.

(2) Next, the above-mentioned honeycomb molded body was dried by using a micro-wave dryer, and after having filled predetermined cells with a paste having a similar composition as the above-mentioned honeycomb molded body, the resulting honeycomb molded body was dried again using a dryer.

(3) Next, five honeycomb molded bodies, fabricated through the above-mentioned processes (1) and (2), were placed on the degreasing jig 10 shown in FIG. 1; then, the degreasing jig was sent into a degreasing furnace with a continuous system through a belt conveyor, to be heated at 300° C. under N₂ atmosphere.

The degreasing jig 10 used here was provided with the grid-pattern body 12 woven to have an open space (opening diameter) of 280 μm, with a linear wire made from stainless steel having 140 μm in diameter.

Moreover, at the time of placing the honeycomb molded bodies on the degreasing jig 10, the honeycomb molded bodies were placed through spacing members consisting of a carbon cloth having a density of 0.1 g/cm³.

(4) Next, the grid-pattern body 12 of the degreasing jig 10 was removed together with the supporting member 13, and a frame shaped side wall member serving as a side wall was placed on the placing jig 11, with the honeycomb molded bodies subjected to the degreasing treatment placed thereon, to provide a firing jig with degreased honeycomb molded bodies placed thereon.

Then, this firing jig was sent into a firing furnace to be fired at 2200° C. in a normal-pressure argon atmosphere for 3 hours, so that a honeycomb fired body having a shape as shown in FIGS. 5A and 5B, the size of 34 mm×34 mm×300 mm, the number of cells 45 pcs/cm², the thickness of a cell wall 0.25 mm, and made of silicon contained silicon carbide (Si—SiC), was fabricated.

(5) Next, the extraneous matters removing apparatus provided with the brush provided roller shown in FIG. 3A, was used to remove the extraneous matters deriving from carbon cloth, and adhered to the side face of the honeycomb fired body.

(6) Thereafter, a similar way as in the processes (6) to (11) of Example 1 was carried out to manufacture a honeycomb structured body.

### Example 8

A honeycomb structured body was manufactured in a similar way as in Example 7, except that, in the process (5) of Example 7, a method for removing the extraneous matters by spraying compressed air from a nozzle was carried out as an alternative to removing the extraneous matters with the brush provided roller.

### Example 9

A honeycomb structured body was manufactured in a similar way as in Example 7, except that, in the process (5) of Example 7, a method for removing the extraneous matters by buffing was carried out as an alternative to removing the extraneous matters with the brush provided roller.

In the present Example, the disk type buff which contained aluminium silicate as an abrasive grain was used as the buff.

### Example 10

A honeycomb structured body was manufactured in a similar way as in Example 7, except that, in the process (5) of Example 7, a method for removing the extraneous matters by sponge polish was carried out as an alternative to removing the extraneous matters with the brush provided roller.

In the present Example, urethane sponge which contained aluminium silicate as an abrasive grain was used as the sponge.

### Example 11

A honeycomb structured body was manufactured in a similar way as in Example 7, except that, in the process (5) of Example 7, a method for removing the extraneous matters by grinding stone was carried out as an alternative to removing the extraneous matters with the brush provided roller.

In the present Example, the resinoid grinding wheel was used as the grinding stone.

### Example 12

A honeycomb structured body was manufactured in a similar way as in Example 7, except that, in the process (5) of Example 7, a method for removing the extraneous matters by polishing sheet was carried out as an alternative to removing the extraneous matters with the brush provided roller.

In the present Example, a polishing sheet containing a sheet abrasive having the grain size of #A60, while being made from aluminum oxide, in a sheet like object consisting of a nylon nonwoven fabric, was used as the polishing sheet.

### Comparative Example 1

A honeycomb structured body was manufactured in a similar way as in Example 1, except that the process (5) of Example 1, that is, removing of the extraneous matters was not carried out.

### Comparative Example 2

A honeycomb structured body was manufactured in a similar way as in Example 7, except that the process (5) of Example 7, that is, removing of the extraneous matters was not carried out.

The honeycomb structured body manufactured in the Examples and the Comparative Examples were cut through the sealing material layer (adhesive layer) which bond the honeycomb fired bodies to one another, and visual observation by using microscope was carried out on the cut surface (cut surface of the adhesive layer).

As a result, in the honeycomb structured body manufactured in the Examples, voids were not observed in any part of the sealing material layer (adhesive layer). Meanwhile, in the honeycomb structured body manufactured in the Comparative Examples, voids were observed. Moreover, the observed voids presumably resulted from the adherence of the extraneous matters.

What is claimed as new and desired to be secured by Letters Patent of the United States is:

1. A manufacturing method of a honeycomb structured body including a honeycomb fired body comprising:
fabricating a pillar-shaped honeycomb molded body having a large number of cells longitudinally placed in parallel with one another with a cell wall therebetween by molding a ceramic raw material, and
firing of said honeycomb molded body,
wherein
said manufacturing method further includes removing of extraneous matters adhered to a surface of said honeycomb fired body after said honeycomb molded body has been fired.

2. The manufacturing method of a honeycomb structured body according to claim 1,
wherein
the firing of said honeycomb molded body is carried out in a state in which said honeycomb molded body is placed in a firing jig through a spacing member, and after the firing, the extraneous matters adhered to the surface of said honeycomb fired body deriving from said spacing member are removed.

3. The manufacturing method of a honeycomb structured body according to claim 2,
wherein
material of said spacing member is the same as that of said honeycomb fired body.

4. The manufacturing method of a honeycomb structured body according to claim 2,
wherein
said spacing member comprises a carbon cloth, a graphite sheet, or a carbon sheet.

5. The manufacturing method of a honeycomb structured body according to claim 2,
wherein
said spacing member is provided in at least two places for one honeycomb molded body.

6. The manufacturing method of a honeycomb structured body according to claim 2,
wherein
said spacing member has a flat shape.

7. The manufacturing method of a honeycomb structured body according to claim 2,
wherein
when firing said honeycomb molded body, a plurality of said honeycomb molded bodies are successively fired, and the installation position of said spacing member is at almost the same position for each honeycomb molded body.

8. The manufacturing method of a honeycomb structured body according to claim 1,
wherein
the removing of said extraneous matters is carried out by using at least one kind selected from the group consisting of a brush, a buff, a sponge, a grinding stone, air spraying, and a brush provided roller.

9. The manufacturing method of a honeycomb structured body according to claim 1,
wherein
the firing of said honeycomb molded body is carried out with said honeycomb molded body placed on a firing jig on which powder is dispersed, and after the firing,
the extraneous matters deriving from said powder adhered to the surface of said honeycomb fired body are removed.

10. The method for manufacturing a honeycomb structured body according to claim 1,
wherein
at least two honeycomb molded bodies are fired in a state in which a first honeycomb molded body is placed on a firing jig through a spacing member, and further a second honeycomb molded body is placed on the first honeycomb molded body through a spacing member, and after the firing,
the extraneous matters adhered to the surface of said honeycomb fired bodies deriving from said spacing member are removed.

11. The method for manufacturing a honeycomb structured body according to claim 1,
wherein
the extraneous matters adhered to an upper surface of said honeycomb fired body and the extraneous matters adhered to an under surface of said honeycomb fired body are simultaneously removed.

12. The method for manufacturing a honeycomb structured body according to claim 1,
wherein
the extraneous matters adhered to the upper surface of said honeycomb fired body and the extraneous matters adhered to the under surface of said honeycomb fired body are separately removed.

13. The manufacturing method of a honeycomb structured body according to claim 1,
wherein
the removing of the extraneous matters adhered to the surface of said honeycomb fired body is carried out by moving said honeycomb fired body on a belt conveyor, and pressing said honeycomb fired body against said belt conveyor by a pressing member.

14. The manufacturing method of a honeycomb structured body according to claim 13,
wherein
the removing of said extraneous matters adhered to the surface of said honeycomb fired body is carried out by stopping the moving of said honeycomb fired body on said belt conveyor for a predetermined time, and removing the extraneous matter while the moving is stopped.

15. The manufacturing method of a honeycomb structured body is according to claim 1,
wherein
the removing of said extraneous matters is carried out in a fixed range of the under surface and/or the upper surface of said honeycomb fired body.

16. The manufacturing method of a honeycomb structured body according to claim 1,
wherein
the removing of said extraneous matters is carried out on the whole region of the under surface and/or the upper surface of said honeycomb fired body.

17. The manufacturing method of a honeycomb structured body according to claim 8,
wherein
said brush includes one kind selected from the group consisting of a channel strip brush, a channel-type roll brush, a wheel brush, a cup brush, a coil brush, a twist brush, a bevel brush, and a pen brush.

18. The manufacturing method of a honeycomb structured body according to claim 8,
wherein
material of said brush includes one kind selected from the group consisting of nylon fiber, aramid fiber, acrylic fiber, stainless steel lines, brass lines, and wrapping lines.

19. The manufacturing method of a honeycomb structured body according to claim 8,
wherein
the rotational frequency of said brush provided roller is at least about 50 min⁻¹ and at most about 200 min⁻¹.

20. The manufacturing method of a honeycomb structured body according to claim 8,
wherein
the velocity of the air sprayed to said honeycomb fired body upon removing of said extraneous matters by said air spraying is at least about 1 m/sec and at most about 10 m/sec.

21. The manufacturing method of a honeycomb structured body according to claim 8,
wherein
said buff includes one kind selected from the group consisting of an abrasive grain containing disk type buff, an abrasive grain containing flap type buff, an abrasive grain containing swirl type buff, and a non-abrasive grain-polypropylene nonwoven fabric.

22. The manufacturing method of a honeycomb structured body according to claim 8,
wherein
said sponge includes one kind selected from the group consisting of an urethane sponge with abrasive grains adhered thereto, a nylon nonwoven fabric with abrasive grains adhered thereto, and an acrylic with abrasive grains adhered thereto.

23. The manufacturing method of a honeycomb structured body according to claim 8,
wherein
said grinding stone includes one kind selected from the group consisting of a resinoid grinding wheel, a magnesia grinding stone, a diamond wheel, a rubber control grinding stone, and an epoxy control grinding stone.

24. The manufacturing method of a honeycomb structured body according to claim 1,
wherein
said honeycomb structured body has a configuration in which a plurality of said honeycomb fired bodies are bonded to one another through a sealing material layer.

25. The manufacturing method of a honeycomb structured body according to claim 1,
wherein
said honeycomb structured body is formed by a single piece of said honeycomb fired body.

26. The manufacturing method of a honeycomb structured body according to claim 1,
further comprising
sealing of either end of each of said cells with a plug paste.
